(19) United States
(12) Patent Application Publication
(10) Pub. No.: US 2004/0098664 A1
(43) Pub. Date: May 20, 2004

(54) Document processing based on a digital document image input with a confirmatory receipt output

(76) Inventors: Derek A. Adelman, Belmont, CA (US); William R. Softky, Menlo Park, CA (US); Jason Lu, Mountain View, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/700,907

(22) Filed: Nov. 3, 2003

Related U.S. Application Data
(60) Provisional application No. 60/441,899, filed on Jan. 21, 2003.
(60) Provisional application No. 60/423,956, filed on Nov. 4, 2002.
(60) Provisional application No. 60/502,149, filed on Sep. 10, 2003.

(51) Int. Cl. G06F 17/00

(52) U.S. Cl. 715/500

(57) ABSTRACT

A system for document processing includes a user interface unit and a command unit having a context server, and an image I/O device interface. The command unit is coupled to a conventional application server and an image capture and generation device for routing image data and commands to the application server for processing. The user interface unit accepts commands and displays information to a user. The user interface unit sends data to and receives data from the command unit. The command unit is responsive to the user interface device and initiates a task or process by setting a context and passing that context and data to the application server. The device interface is coupled to the context server and the image capture and generation device. The context server controls processing of the image data according to the context, and then generates a receipt image and sends it to the device interface for output to the image capture and generation device. The present invention also includes a method for performing an operation or task on a document comprising the steps of: receiving a command identifying an operation or task; capturing an image; performing the operation or task identified in the command using the captured image as data; and generating and outputting a receipt.

### CROSS-REFERENCE TO RELATED APPLICATION

This application claims the benefit of U.S. Provisional Patent Application No. 60/441,899 filed on Jan. 21, 2003, which is incorporated herein by reference.

### BACKGROUND OF THE INVENTION

1. Field of the Invention

The present invention relates generally to image processing, and more particularly, to workflow coordination and image processing of a document with a confirmatory receipt output.

2. Background Art

Despite decades-old predictions of the computerized “paperless office,” paper use has increased steadily throughout the computer revolution. People not only have to use paper forms and receipts, but they seem to prefer using paper. But the Information Technology (IT) industry remains persistent in its effort to eliminate paper wherever possible. The main reason the IT industry wants to eliminate paper is because enterprise IT systems need “structured data,” which involves well-defined formats like databases, spreadsheets, and XML, as input to operate. The IT industry's solution to processing “unstructured” data such as that printed on paper is to spend a huge amount of money, time and effort to convert it into structured data, by manual key-entry or optical form-reading. This is an all-or-nothing process and the prior art does not provide any mechanisms to incrementally, or partially integrate paper flow into the transformation of data to electronic form, or vice versa.

There are many inherent advantages to paper documents that will make the dream of a “paperless office” nearly impossible. These advantages include the permanency of paper; the unavoidability of paper in some circumstance such as legal contracts and receipts; and user preference for a medium that is tangible, convenient and easily portable. Unfortunately, the stubborn persistence of paper alongside the increasing popularity and use of computers has created two independent, incompatible streams of office information.

Another related issue is workflow and context. A piece of paper by itself, sitting on a desk or in an inbox, draws little attention to itself. An invoice does not cry out to anyone that it must be paid. Thus, companies go to great lengths to develop processes which sort and route documents, manually or electronically, so that the actions that these documents demand are performed by the appropriate people, and follow processes set by the company as optimum. Various business processes or “workflows” have been developed. “Workflow context” is a representation of the role that a document plays within a company's workflow. As such, the job of transforming a paper document into a stored electronic image is often tightly coupled with the introduction of as much contextual information as possible without introducing undue constraints that would inhibit workflow. However, there are not any easy to use and effective ways to capture and use the context of the document so the document can be processed further, electronically or otherwise.

The process of coordinating movement of data can be described and will be described throughout this document in terms of a “workflow.” The workflow represents how data moves from stage to stage, being acted upon, transformed, manipulated, and forwarded to the next step, (e.g., approving purchases, processing applications, gathering information, generating documents, etc.). For thousands of years workflow has been done on paper (or papyrus, or clay).

Pushing workflow onto computers is a very recent idea. It can work well, if everyone has a computer, all the necessary data is structured in the same format and available, and the process is rigidly defined. But computerized workflow is much harder where “real life” intervenes, with unexpected data fields, unusual situations, or legacy paper-based systems. This is the case in document-centric companies, with a lot of unstructured data (such as receipts, purchase orders, checks, evidence, cover letters, lab notes, contracts, and invoices). So corporate workflow is typically where paper-based and electronic systems collide most strongly, and where a unified solution would provide the most benefit.

Today, workflow “streamlining” is limited to the interaction of diverse systems handling structured data. Many expensive solutions simply map one data representation to another. Yet paper always keeps leaking back into corporate workflow. A traditional, laborious, and expensive solution is to transform non-structured paper data to a structured form, for example, by form scanning or keyboard entry, then push it into the automated workflow system. Companies with only modest legacy paper can adopt such solutions readily and affordably. But most companies in more established, paper-intensive industries that would still benefit from workflow automation find the projects grounded by the investment and energy required to deal with paper.

Businesses are forever stuck with both structured and unstructured data. This is partly because structured data is a very recent phenomenon; partly because the data structures themselves keep changing (relational schema, XML, LDAP . . . ); and partly because the transition from unstructured data to structured data is expensive, and never complete.

Enterprise application integration product companies and systems integrators tend to overlook the importance of integrating non-structured data, preferring to implement entirely new solutions in order to replace it. But this approach does not work for “document-centric” companies, and such companies are important customers to office equipment manufacturers.

The current art has also invested significantly into having equipment for copying paper documents. Such equipment represents a significant investment for a company. It is also a tool that is easy to use and used by many employees in companies. Thus, businesses are very reluctant to transition away from such equipment that has high value and usability.

Accordingly, there is a need for a system that works with unstructured data such as that printed on paper to integrate document management cleanly into information processing workflow.

### SUMMARY OF THE INVENTION

The above needs are met by a system and method for document processing based on image input after which a receipt is provided. In particular, the present invention provides a command system formed from a lightweight technology layer that interfaces with conventional input/output devices, a method for establishing the “context” of a document image as it is scanned and for processing it based on that context, and other valuable applications.

The system according to the present invention preferably includes a user interface unit and a command unit. The command unit further comprises a context server and a device interface. The command unit is coupled to a conventional application server and, via the device interface, an image capture and generation device such as a digital copier. The user interface unit is capable of accepting commands and displaying information to a user. The user interface unit is coupled to the command unit to send and receive data. The command unit is coupled to the image capture and generation device, via the device interface, and to the application server for routing image data and commands to the application server for processing. The command unit is responsive to the user interface device and initiates a task or process by setting a context and passing that context and image data to the application server. The application server processes the image data according to the context and signals completion to the context server. In turn, the context server generates a receipt and sends it via the device interface to the image capture and generation device for output.

The present invention includes a method for performing an operation or task. The method preferably comprises the steps of: receiving a command; soliciting or extracting context information; identifying an operation or task; capturing an image; performing the operation or task identified in the command using the context information and captured image as data; and generating and printing a receipt. More particularly, in an exemplary system, a user takes a piece of paper to a photocopier, signals the task she wishes accomplished, supplies context information, and allows the photocopier to “scan” the paper. This image or “copy” together with the context information is then used as input to control the processing of the same copy, or of one or more subsequent input documents. Once the processing is complete, the photocopier outputs a paper confirmation confirming the task was accomplished correctly; or, if an error was encountered, that processing was prevented and error-related information. This confirmation may also act as the final output of the task.

The present invention is particularly advantageous in three respects. First, the present invention generates a physical receipt (such as a thumbnail of the image, the image context, an identification of a task, an indication of the completion of the task, the results of the task, scored surveys of tests, Optical Character Recognition, or zero results text). Second, the present invention provides a new system and method for inputting commands and data for workflow control and operation. Third, it can easily be added to existing systems to provide scan-act-respond capabilities.

### BRIEF DESCRIPTION OF THE DRAWINGS

FIG. 1A is a block diagram of a document processing system including the command system of the present invention.,

FIG. 1B is a block diagram of an exemplary embodiment of the document processing system of the present invention.

FIG. 2 is a flowchart of a preferred method for receiving input, processing a document and generating a receipt according to the present invention.

FIGS. 3A and 3B are a more detailed flow diagram for an embodiment of the present invention that utilizes a network of distributed workers for processing the input document.

FIG. 4 illustrates a second embodiment of a document processing system including an integrated command system.

FIG. 5 illustrates a third embodiment of the document processing system of the present invention employing a central hub topology.

FIG. 6 illustrates a fourth embodiment of the document processing system.

FIG. 7 illustrates a detailed block diagram of one embodiment for the command unit of the present invention.

FIG. 8 is a block diagram of one embodiment of session manager according to the present invention.

### DETAILED DESCRIPTION OF THE INVENTION

A first embodiment of the system includes a system 100 and method for generating a receipt, or confirmation, for a task performed by the system 100 upon receiving an input document from a user. Throughout this application the term “receipt” will be used to indicate a document returned to the user that confirms that the system 100 has properly carried out a workflow based on the input or that an error has occurred and what the error is. The receipt contains at least some information from the input document, but may be processed or augmented during execution of the workflow before being returned to the user. As noted above, the receipt will serve as confirmation and proof that the document was correctly processed. Additionally, the receipt may actually be the final product of the workflow, and in most instances, the receipt will be returned to the user.

The term “context” may also be used to describe the type of processing being performed on the input document. However, “context” will most often refer to the overarching workflow that is to be performed with the image data as input. Typically, the user selects the context, and the system 100 matches the context to a corresponding workflow. Once initiated, the image data is processed according to the workflow. Some workflows need no additional input from the user. However, for most workflows, the system 100 may request additional input from the user such as which branch in a workflow to take in the processing of the data, or to request additional documents be scanned, or for other instructions for processing the input.

The type of receipt generated depends primarily on the workflow initiated by the user. As will be discussed in greater detail below, the workflow may be triggered by the user selecting the context at the start of a session, or may be automatically detected based on the content of the first document input during a session. In general terms, a workflow is a set of tasks to be performed that depend on information contained on the document, on its image, or on the data contained therein. A workflow may be static, or may be changed based on the data being processed. Specific workflows will be discussed near the end of this application.

As briefly noted above, a user's interaction with the system 100 is divided into sessions. Sessions are used to ensure that a workflow may interact with a user without affecting the process. For instance, a session may begin when the user selects a workflow or context, and may last until the receipt is generated and output to the user. During the session, the system 100 keeps track of the steps being performed on the document/data and may present the user with additional choices or requests. The session may also dictate whether the image input output (IIO) device (such as the copier) 106 may be used for other purposes, with the device 106 optionally being locked while the session is active, unless additional input is required. For some applications the input device 106 is locked, while for others it is not locked. A particular advantage of the present invention is that input device 106 need not be locked. In fact, the input device 106 can be used for more traditional uses, including copying, printing, and scanning, without regard to its possible involvement in workflow sessions that are maintained between a command system 102 and a worker 104.

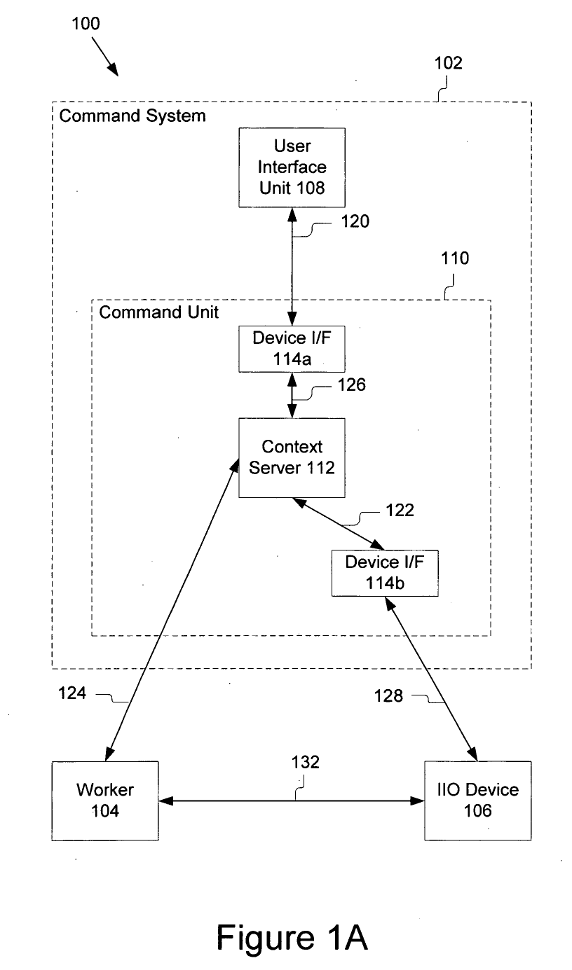

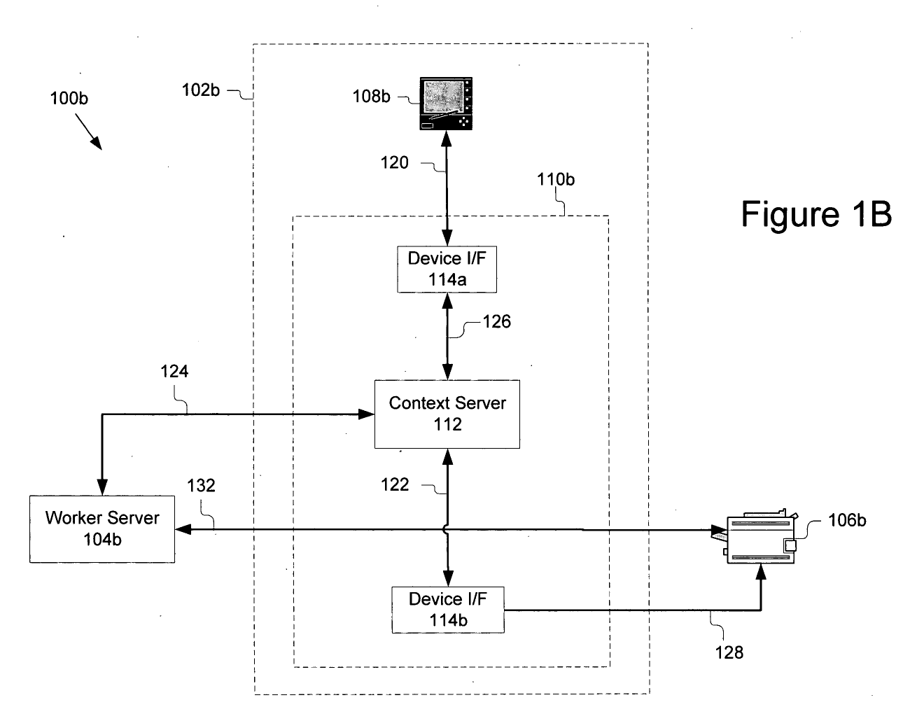

Referring now to FIG. 1, a preferred embodiment of a document processing system 100 including the present invention is shown. The document processing system 100 preferably comprises a command system 102, at least one worker 104 and an image input output (IIO) device 106. In a preferred embodiment, the command system 102 is coupled to the worker 104 by signal line 124 and to the IIO device 106 by signal line 128. The command system 102 is used to accept commands from a user as well as control and respond to the operations of the worker 104 and the IIO device 106. As shown in FIG. 1, the worker 104 is also coupled to the IIO device 106 by a signal line 132 such as by an Ethernet connection. In an alternate embodiment, the coupling of the worker 104 to the IIO device 106 is not required and image data can be transmitted between these devices via the command system 102.

The command system 102 comprises a user interface unit 108 and a command unit 110. In its most basic form, the user interface unit 108 is a device for presenting information to and for receiving information from the user. Thus, the user interface unit 108 includes a means for outputting information to the user such as a visual display like an LCD display, series of lights, or LEDs; a speaker for audio output or any other method for providing information to the user. The user interface unit 108 also includes a means for inputting commands and data such as buttons, a stylus, a touch screen, keyboard, mouse-type controller, microphone or any other method for inputting information to the command system 102. In one embodiment, the user interface unit 108 is a personal digital assistant. In other embodiments, the user interface unit 108 may be custom made hardware having one or combinations of the examples of input and output means described above.

The command unit 110 further comprises a context server 112 and one or more device interfaces 114a, 114b.

The context server 112 is coupled to the user interface unit 108 by the device interface 114a and signal lines 120, 126; to the IIO device 106 by the device interface 114b and signal lines 122, 128; and to the worker 104 by signal line 124. The context server 112 is responsible for controlling the operation of the worker 104 and the IIO device 106 based on input received from the user interface unit 108. The context server 112 also provides information for display on the user interface unit 108 and receives commands from the user interface unit 108. More particularly, the context server 112 accepts user input such as logging into the command system 102, commands for a workflow, or selection of an application or workflow. The context server 112 also creates, maintains and ends sessions for particular workflows as will be described below in more detail. The context server 112 also communicates/negotiates indirectly with the IIO device 106 and more directly with the worker 104. The context server 112 manages the routing of image flow between the IIO device 106 and the worker 104. Finally, the context server 112 controls creation of the confirmatory receipt, which the context server 112 may perform or delegate to the worker 104. It should be noted that FIG. 1 illustrates the various connections to the context server 112 contemplated by the present invention. In certain cases, some workers 104 communicate using the same language and have the same level of functionality as the context server 112, and thus, can be connected for communication with only a signal line 124. Others however, require a device interface 114a, 114b and signal lines 120, 122, 126, 128 in order to communicate with the context server 112. While the device interfaces 114a, 114b are shown as separate modules; those skilled in the art will recognize that a single interface device could be used to couple the context server 112 to a plurality of other devices or even all the other devices.

The device interface 114b is coupled to the context server 112 and the IIO device 106 by signal lines 122 and 128 respectively. The device interface 114b is responsible for sending scan, print, copy, lock, and unlock device commands to the IIO device 106 in response to commands and data from the context server 112. The device interface 114b ensures that the context server 112 is aware of the set of commands a given IIO device 106 will accept. This ensures that the context server 112 will not attempt to send a “scan” command, via the device server 114b, to a print only IIO device 106 such as a printer.

The other device interface 114a is coupled to the context server 112 and the user interface unit 108 by signal lines 126 and 120 respectively. The device interface 114a is responsible for receiving commands and context data from the user and sending data and commands to the user interface unit 108 in response to interaction with the context server 112. The device interface 114a ensures that the context server 112 is aware of the set of commands a given user interface unit 108 will accept, and understands commands and data received from the user interface unit 108.

In simplest terms, a worker 104 is any processing unit that is included in a given workflow for processing or operating on the document/data. Some common examples of workers 104 include: the processor in the photocopier, a dedicated processing server, an image reformatter, or an enterprise application acting as part of the company's enterprise solution, such as a central archive, database, or form-reading system. A worker 104 may also be either a dedicated hardware machine, or may be any routine running on a general-purpose computer that has access to the data flow of the workflow. For example, the worker 104 may be one or more application servers capable of processing images, performing optical character recognition (OCR), updating enterprise workflow, and sending confirmation. These examples are used to provide an understanding of the nature of the worker 104 and are not meant to limit the workers to a specific type of processing machine.

The IIO device 106 is any device or group of devices capable of capturing a digital image from a paper document and/or printing a digital image. In the preferred embodiment, the IIO device 106 is a multifunction digital copier, but the IIO device 106 could also be a scanner or printer as will be described below for other embodiments. The IIO device 106 must be able to scan documents or create images of them. The IIO device 106 preferably is also able to process print jobs and thus generate documents. The IIO device 106 is coupled to the command unit 110 by signal line 128 to send and receive images and commands. The IIO device 106 may also be coupled directly to the worker 104 by signal line 132 as has been noted above. It is also possible in alternate embodiments that IIO device 106 can be embodied so as to only have image capture capability or only have an image generation capability, for example, with only a scanner and a printer.

The elements of the system 100 have been described above as being communicatively coupled by a plurality of signal lines 120, 122, 124, 126, 128 and 132. Those skilled in the art will recognize that the signal lines 120, 122, 124, 126, 128 and 132 may be direct coupling, coupling by Ethernet or some other networking protocol and structure, optical coupling or even may be a wireless connection such as a radio frequency connection.

Referring now to FIG. 1B, an exemplary embodiment of the system 100b is shown with the worker 104b, IIO device 106b, the context server 112, the device interfaces 114a, 114b and the user interface unit 108b implemented with particular devices. For example, the worker 104b may be a conventional application server operating in an enterprise network and the IIO device 106b may be a digital photocopier with a USB port. One particular application server is a reformatter. The reformatter may be included in a workflow whenever a particular worker 104b needs to view the document image in a different format. This may be of particular importance in systems using older copy machines using proprietary image formats, or when the photocopier 106b only supports a limited number of output/input formats for images. By including a separate reformatter, the workers 104 requiring a different format would not have to be modified to perform the conversion themselves, thus allowing for greater flexibility in the system 100b.

The digital photocopier 106b receives input commands from the command unit 110b, and outputs status messages back to the command unit 110b. Additionally, the digital photocopier 106b makes available, the digitized document to the application server 104b and to the context server 112 along with instructions from the command unit 110b about how to handle the image data. The digital photocopier 106b also receives the receipt data back from the device interface 114b for output to the user, for example as a print job. The command unit 110b is separate from the copier 106b. The coupling via line 132 is over a conventional TCP/IP network.

The context server 112 and the device interfaces 114a, 114b may be one or separate computers executing the software of the present invention coupled via an Ethernet LAN, and the user interface unit 108b may be a personal digital assistant such as a pocket PC with a wireless connection 120 to the context server 112. The user interface unit 108b may alternately be a wired or wirelessly coupled touch screen display. The user interface unit 108b is communicatively coupled to the copier 106b, the context server 112, the device interfaces 114a, 114b and at least one application server 104b in order to control workflow and to manage sessions.

The context server 112 is a computer that processes the document, which has been scanned to a disk by the IIO device 106b as a result of a command sent through the device interface 114b, and modifies and augments the data in order to generate the receipt data. This receipt data is communicated back to the IIO device 106b via the device interface 114b for output to the user. While the system 100b shows an individual context server 112, alternate embodiments may provide the functionality of the context server 112 in any or all of the other workers 104b in the system 100b. In system 100b, an individual context server 112 is particularly useful if the remaining workers 104 in the workflow do not require outputting data to the user. In these instances, the context server 112 may be configured to generate a receipt where a receipt would not normally be generated; thus, allowing the user to confirm that the workflow was completed.

The various devices in system 100b may be communicatively coupled in various ways. For instance, the user interface unit 108b may maintain a wireless link via RF or infrared with the command unit 110b, and the command unit 110b may be networked with the remaining devices 104b, 106b. Alternatively, the user interface unit 108b may be hardwired into the network using conventional networking techniques. Likewise, the application servers 104b, device interfaces 114a, 114b and the digital photocopier 106b may be also be wired into the network using conventional techniques. The network itself may be either a LAN, or may be part of the WAN, allowing the devices to communicate across larger geographic spaces as needed. One skilled in the art will recognize that other methods of forming the communication links between the devices may also be used.

The present invention is particularly advantageous over the prior art because it provides a command system 102 implemented with lightweight software integration. Further, the command system 102 creates a new paradigm of “scan-act-respond” for integrating the workflow of documents in paper and electronic form. With the present invention, the user need only scan a document, and the system 100 will act upon the scanned document, and respond by generating a receipt. The present invention provides context based image referencing through use of the user interface unit 108, and is able to synchronize operation of the IIO device 106 so that images and command are appropriately passed to the workflows executed by the worker 104.

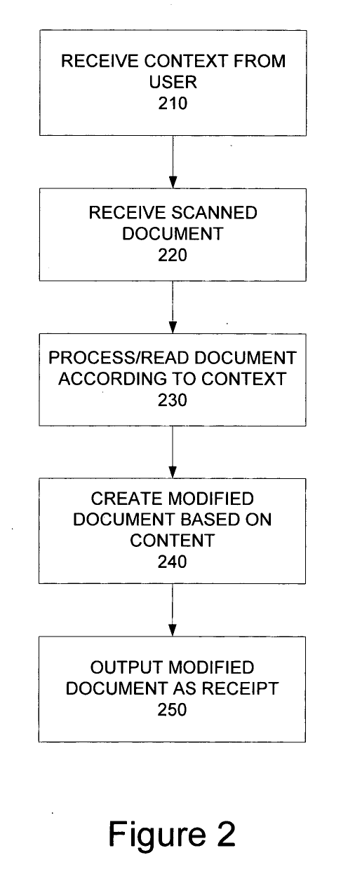

FIG. 2 illustrates a flowchart of the steps implemented by the command system 102 for receiving input and generating a receipt. While the preferred methods will now be described with reference to the preferred embodiment of the system 100 described above with reference to FIG. 1A, those skilled in the art will recognize that the methods are applicable to any of the embodiments disclosed in this application. The command system 102 is activated, and a workflow session is started when the command system 102 receives 210 the context selection from the user. As will be discussed below, this may be achieved by signaling the command system 102 using a user interface unit 108, or may be accomplished by inputting of a first document. In one embodiment, the system 100 stores the context in the command system 102. In another embodiment, the system 100 stores the context in the context server 112.

Once the context is received and the workflow is set by the command system 102, the first (or additional) document is input into the system 100. This document is scanned 220 by the IIO device 106 to form a digital image to be processed by the system 100. The digital image is then processed 230 according to the steps included in the workflow. A worker 104 preferably performs the processing of the image data.

Once the digital copy and/or its data have been processed 230, a receipt is created 240 by the command system 102 by modifying either the original digital copy or its data to reflect that the workflow has properly occurred, or indicate an error and other error information. The receipt may also include other data that is a result of the workflow processing such as OCR, text, or other information. Depending on the context chosen by the user, the receipt may also act as the final output of the system 100. For other contexts, the receipt may simply be proof of submission to a database or to some other electronic processing system. In these situations, the receipt may reflect the system's interpretation of the data and the format in which it was forwarded to the electronic processing system (not shown).

The final step is for the system 100 to output 250 the receipt to the user. In the preferred embodiment, the receipt is sent to the IIO device 106 and printed for the user. In an alternate embodiment, the receipt may be output at a remote location, such as a records department where the paper record may be archived or otherwise entered in a physical file. In yet another embodiment, the receipt is both printed for the user and printed at a remote location. As discussed above, once the receipt is output, the session is terminated and if the IIO device 106 were locked, it would be unlocked.

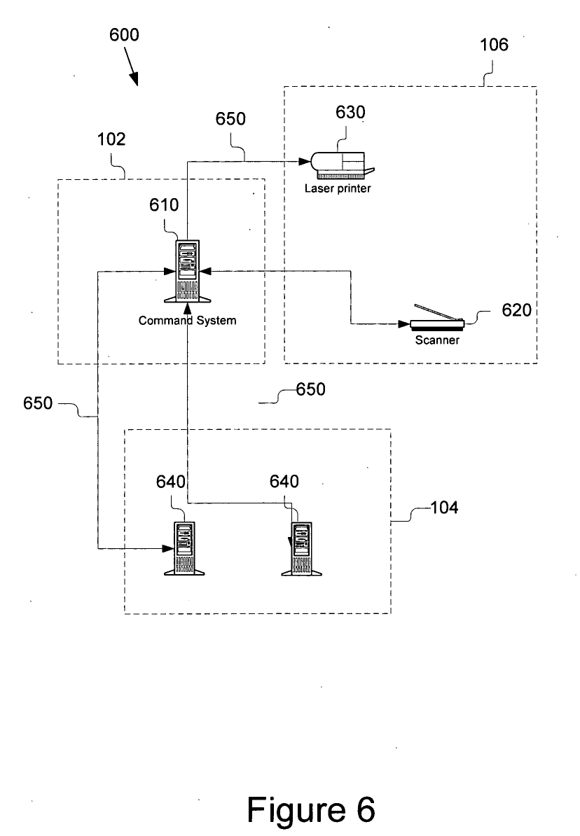

While the present invention contemplates that the method described above may be implemented using a computer 102, a scanner 620, and a printer 630 as illustrated in FIG. 6, the preferred embodiment utilizes a digital copier 106b as the IIO device 106 as illustrated in FIG. 1B. There are several workplace advantages gained by utilizing a digital copier 106b as the point of user interaction with the system 100. A few of the advantages are mentioned below.

The use of a digital copier 106b as the IIO device 106b allows a “pure paper” interface. A “pure paper” interface is defined as a mode of interaction in which the user provides data and programming instructions to the system 100 in hard-copy form, i.e. on paper. The only non-paper-based instruction may be the context selection, though in some embodiments, that may also be done by submitting a piece of paper to the system 100. A pure paper interface typically requires that the user scan the paper data and instructions into the system 100 so that they may be processed and/or manipulated. In the preferred embodiment, the scanning process is done by a digital copier 106b so that a receipt can be printed in the same location as the original scan. This facilitates the understanding of how the system 100 interpreted the processing instructions that were introduced only through the original paper.

There are several advantages to using the “pure paper” interface. First, it ensures that the programming and configuring is relatively simple since it must be able to be expressed on a few pieces of paper. Second, the ease of interacting through paper may seem less intimidating to many users than having to navigate a complex computer menu to choose the function they desire. Presenting a visual (paper) example of a simple computation, such as a filled-out spreadsheet, is, in many cases, more intuitive to a non-technical user than the abstract programming-like expressions that an ordinary spreadsheet interface would require, (e.g., “SUM(a13:a17)”). Such “programming by example” in many simple domains may be easier and simpler for non-technical users.

Tying in with the pure paper interface is the idea that the copier is ubiquitous. Almost all offices have a photocopier, and almost all employees know how to use the photocopier. From this prospective, employees already know how to operate the interface for the present invention, which cuts down on the training required, and also reduces the chance of user error.

Additionally, the photocopier can automatically provide an “audit trail” through the output of the receipt. This eliminates the need for an additional output device, and may give the user a tangible, permanent record of the timing and content of the transaction.

Finally, many office-place workflows already include the step of photocopying a document. By using the photocopier as the input and output device for the system 100, this step may be absorbed by the system 100, saving time and increasing efficiency.

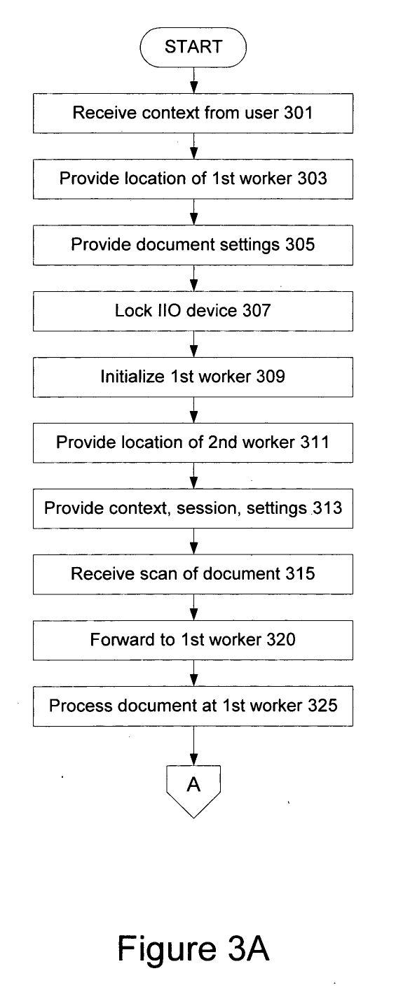

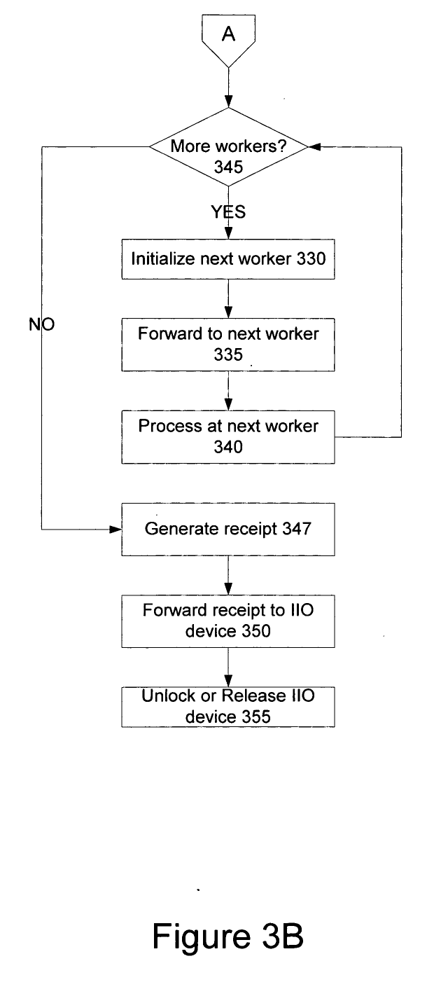

FIGS. 3A and 3B illustrate a more detailed flow diagram for a second embodiment of the method of the present invention that utilizes a plurality of distributed workers 104 for processing the input document.

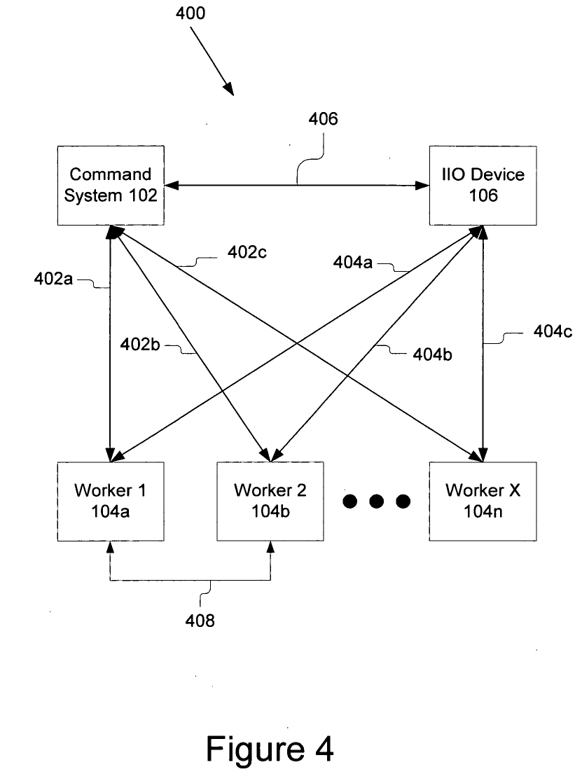

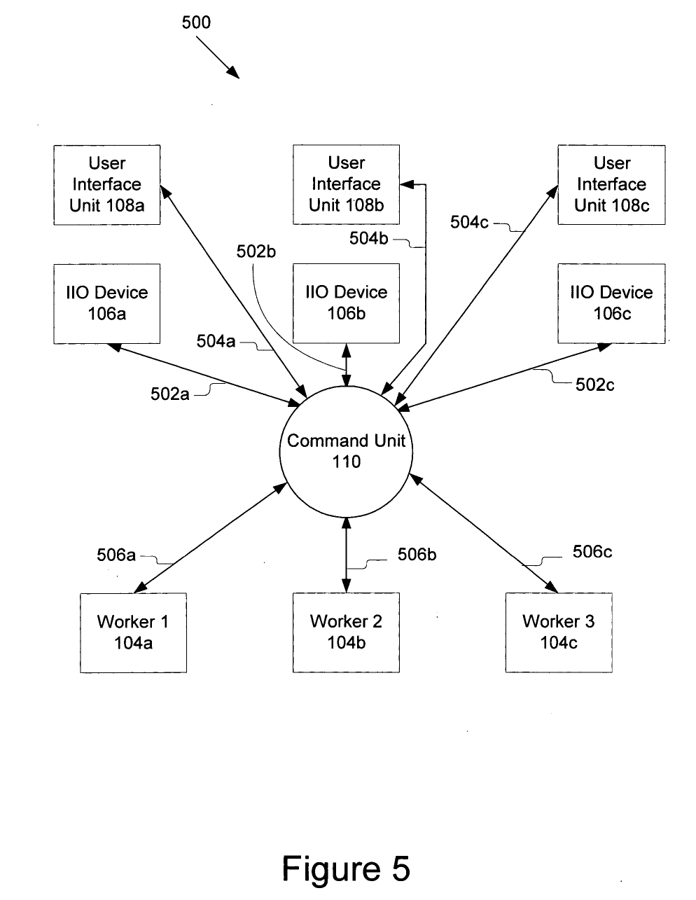

The system 100 described in conjunction with the process of FIGS. 3A and 3B actually uses more than one worker to perform the steps dictated by the workflow. This distributed workflow allows the system 100 to split complicated tasks between machines or processes that may be specifically adapted for a certain workflow task. One example is to have a single OCR server that receives digital document input and converts it into a text document for further processing by the system 100. Distribution of workflow among several workers 104a-n also allows any given worker 104a-n to participate in several workflows. The workers 104a-n in a distributed workflow may be of any type, including but not limited to those described above. A more specific discussion of a multi-worker system 400, 500 will be provided below with reference to FIGS. 4 and 5.

If a digital copier 106b is used as the IIO device 106 in a distributed workflow environment, or any time the workflow is not implemented solely within the copier, the system 100 must use a copier 106b that is capable of transmitting and receiving data from a communication channel 132. In one embodiment, this requires the use of a network-enabled copier 106b with an API accessible by the command system 102 to further control the functions of the copier 106b, and to allow the command system 102 to output the receipt to the copier 106b. Alternatively, the copier 106b may already be a multi-function device capable of accepting print orders.

The method illustrated in FIGS. 3A and 3B operates using the same general principles as discussed above with respect to FIG. 2. Additional detail has been provided to show how a distributed workflow is implemented.

The command system 102 first receives 301 the context selection from the user. This causes the command system 102 to create a new session, to select a workflow corresponding to the input context, and to determine which workers 104a-n will be used, and in what order. For the selected workflow, the command system 102 knows from communication with the worker 104 what document(s) will be expected, as well as the type of receipt that will be generated. Once the context is received 301, the command system 102 provides 303 the IIO device 106 with the address/location of a first worker 104a; provides 305 the IIO device 106 with any settings required to receive and correctly format the document; and optionally locks 307 the IIO device 106 from receiving input or outputting documents not related to the session. It should be noted that locking the IIO device 106 is optional, and if the IIO device 106 is not locked it can be used for other operations such as copying, scanning or printing during the middle of the session. Moreover, the locking and unlocking steps, 307 and 355 are mutually inclusive. Both must be included or excluded. Alternatively, the IIO device 106 may not be provided with the address of the first worker 104a, but may instead be instructed to store the image of the document until accessed by a different worker 104b-n.

Next, the command system 102 initializes 309 the first worker 104a. After initialization, the command system 102 provides 311 the location of the second worker 104b (if there is one) as well as providing 313 the context, session id, and any configuration parameters to correctly process the incoming document to the first worker 104a. Optionally, the first worker 104a may also be instructed to retrieve the stored document from the IIO device 106, if the IIO device 106 was instructed to store the image of the document. The command system 102 next signals the user to input the first document, and unlocks the IIO device 106 to receive 315 and scan the document. After capturing an image of the document, the IIO device 106 then forwards 320 the digital copy to the address provided. Again, as noted above, the IIO device 106 may instead store the document, and allow the first worker 104a to access it directly. The document is processed 325 by the first worker 104a according to the context and settings provided during initialization 309.

Next, the command system 102 determines 345 whether there are additional workers 104b-n that must process the input data or the result of the processing performed by the first worker 104a in step 325. If so, the method continues in step 330. In step 330, the command system 102 initializes the next worker 104b in a similar manner to the initialization 309 (including steps 311 and 313) of the first worker 104a. The work product of the previous worker 104a is then forwarded 335 to the next worker 104b-n and is processed 340 by the next worker 104b according to context and settings provided during initialization 330. After step 340, the method returns to step 345 to again determine 345 whether there are additional workers 104b-n, identified in the workflow that need to process the output of the processing step 340. While the preferred process has been described above as only iterating through each worker 104a-n once, those skilled in the art will recognize that the processing by the workers 104a-n is specified by the workflow, and thus, a particular worker 104a may be used multiple times within a single workflow, for example, if the worker 104a performs a simple task such as querying a database using certain portions of the input image, a single workflow may have multiple queries of a data base.

If the method determines in step 345 that no more workers 104a-n need to process the data, the method proceeds to step 347. Once the workflow is complete and there are no additional workers 104a-n required to process the data, then a receipt is generated 347 based on the processing done according to the workflow. The receipt is generated 347 by the final worker 104n, or may be generated by a specific context server 112. Once generated 347, the receipt is forwarded 350 back to the IIO device 106 for output to the user. The command system 102 then unlocks 355 the IIO device 106 and allows the receipt to be output. At this point, the workflow is complete and a new workflow may be initiated.

While the steps have been presented in a specific order, one skilled in the art will recognize that several of the steps may be performed in a different order. Additionally, one skilled in the art will recognize that several other signaling and addressing methods may be used to coordinate the transfer of data and control between workers 104a-n. For example, the workers 104a-n may not be provided any information regarding the address or location of any other worker 104a-n during initialization, but may instead simply receive and pass data from a central controller. Additionally such an alternative may also require the IIO device 106 to simply store the scanned image and instruct the workers 104a-n to access it directly, instead of having the IIO device 106 forward large quantities of data to the workers 104a-n. This alternative will be discussed in greater detail in connection with FIG. 5.

In discussing FIGS. 3A and 3B, the concept of splitting the workflow tasks across several workers 104a-n was introduced, as well as the concept of the user interacting with the workflow. However, to provide efficient management of the workflow and to keep track of each session, it is beneficial if the command system 102 includes a command unit 110.

The role of the command unit 110 is that of a traffic controller. The command unit 110 interfaces with the user interface unit 108 to interact with and control the command system 102. The command unit 110 coordinates the communication between different parts of the system 102, such as between workers 104a-n and the IIO device 106. It is the responsibility of the command unit 110 to ensure that a workflow is completed correctly, and to make sure that each part of the command system 102 is utilized in the correct sequence, and for the correct task.

The command unit 110 may be incorporated into the command system 102 in any of several manners. In the preferred embodiment, the command unit 110 includes server software operating on a server (which may also operate as a worker) that is communicatively coupled to client software running on a personal digital assistant (PDA). Alternatively, the entire command unit 110 may be contained in software operational on a PDA or pocket PC. In another embodiment, the command unit 110 may be a plurality of separate process running in the IIO device 106, and may use the interface of the IIO device 106 or even the photocopier's scanning of the document, to interact with the user.

As mentioned above, the preferred embodiment for the IIO device 106 is a networked digital photocopier. Such networked digital photocopiers are available in the art. Conventional networked digital photocopiers already provide copying functions, as well as the ability to send and receive digital images across the network. Since a photocopier is a significant business investment, it is advantageous to provide a command system 102 that extends the functionality of these conventional networked digital photocopiers. In yet another embodiment, the IIO device 106 may be a low end digital copier, the command system 102 may be a PDA and a personal computer, and the “communication channel” between the IIO device 106 and the command system 102 may be a combination of wireless communication connections and USB connections between the low end digital copier, the PDA and the personal computer.

The command system 102 may interact with the conventional networked photocopiers through the copier's API, allowing it to provide instructions and session control to the copier; as well as sending receipt document data to the copier for printing.

In a preferred embodiment, the system 100 utilizes a command system 102 formed as a physically separate unit from the IIO device 106. This separate unit may include a wireless PDA-like device, or may include a wired console installed near the IIO device 106. One advantage to providing the command system 102 physically separate from the actual IIO device 106 is that the command system 102 functions may be centralized and standardized across the company without having to implement a separate command system 102 for every IIO device 106. This is particularly advantageous because it allows the present invention to be used with a variety of different brands and models of photocopiers that may already exist within a company, yet provide a consistent way of using the system 100. Providing a command system 102 separate from the IIO devices 106 also allows for the quick replacement or upgrade of an IIO device 106 without requiring substantial reprogramming of its interface. The command system 102 need only be aware of what API calls to use when communicating with the IIO device 106.

As discussed above, in the preferred embodiment, there are at least two components comprising the command system 102: the user interface unit 108 and the command unit 110. While each copier may have a dedicated user interface unit 108, such as its own display screen or PDA-like device, the command unit 110 may run on a centralized server, and may be shared by many photocopiers. The command unit 110 preferably contains information about the API's of many different makes and models of copiers, so that updates in the workflow for the entire photocopier network could be made at a single point, and monitoring or archiving of all the copier-related workflow would be automatically centralized. In an alternative embodiment, the command system 102 may be formed as a single unit, with the user interface unit 108 and the command unit 110 residing together in a single device, such as the PDA-like device.

While the discussion above focuses on a command system 102 that is physically separate from the IIO device 106, it is to be understood that the command system 102 may exist attached to, or as an integrated part of, the IIO device 106 (e.g., a photocopier) allowing for a single integrated workflow device. Likewise, in a command system 102 that uses a separate user interface unit 108 and command unit 110, the user interface unit 108 may be physically attached or integrated with the IIO device 106.

FIGS. 3A and 3B provide several examples of the functions and responsibilities of the command system 102. The command system 102 may receive 301 the context from the user. This may be done by presenting the user with a list of workflow options and letting the user select a workflow. Alternatively, the user may input a piece of paper into the IIO device 106 that is analyzed by the command system 102 to determine the context.

The command system 102 is also responsible for initializing the IIO device 106 (step 305), and the workers 104a-n (steps 309 and 330). The command system 102 provides the current worker 104a-n with the context and/or task to be performed on the data to be received. In one embodiment, as part of the steps of initializing the workers 104a-n, the command system 102 tracks the progress of the workflow in order to provide the current worker 104a with the address of the next worker 104b-n. In another embodiment, the workers 104a-n only communicate with the command system 102, and the command system 102 must track the progress of the workflow so that it can properly coordinate the data that it sends and receives between workers 104a-n.

As noted above, the command system 102 also acts as a traffic cop. In this regard the command system 102 controls when and where the data is sent within the system 100. More specifically, in one embodiment, along with providing the forwarding addresses to each worker 104a-n, the command system 102 may trigger the actual steps of forwarding the document from the IIO device 106 (step 320) to and between the workers 104a-n (step 335). The command system 102 may also route 350 the receipt data back to the IIO device 106 for output to the user.

Finally, the command system 102 is also responsible for maintaining the session until the receipt has been output. Session management includes tracking the workflow and the operation of the system 100, as well as interacting with the user when required. The command system 102 may also manage logging in the user, authenticating her, and determining which applications and workflows she has access to. Another part of session management includes locking 307 and releasing 355 the IIO device 106 as appropriate to make sure that only documents belonging to that session are input or output during the session. This may be important in an office that utilizes a distributed worker network to process several sessions from different copiers simultaneously. The command system then makes sure that the correct operation is done at the correct time and output to the correct device, and ensures that no user's session is interrupted by other output such as queued print jobs.

FIG. 4 illustrates a second embodiment of a workflow system 400 incorporating a command system 102. In the workflow system 400, the command system 102 plays a supervisory role and does not need to handle every message or every piece of data. System 400 includes the command system 102, an IIO device 106, and a plurality of distributed workers 104a-n. The command system 102 provides input to every other device 106, 104a-n. This allows the command system 102 to initialize and configure each device 106, 104a-n for its role in the workflow.

The connecting lines in FIG. 4 represent data and command paths, and do not necessarily reflect physical couplings in the system 400. The system 400 may use any form of hardware communication that facilitates the communications lines depicted in FIG. 3. One example of a hardware communication system that may be used by system 400 to connect each component in the system 400 is a LAN.

In system 400, the IIO device 106 (a scanner or preferably a digital networked photocopier) may communicate the scanned document to any of the plurality of workers 104a-n. However, as discussed above, the command system 102 may control where and when the IIO device 106 transmits its data, as well as when it receives a document from the user. Likewise, each worker 104a-n may communicate the information directly to another worker 104a-n, but may still be monitored and controlled by the command system 102. This allows the command system 102 to signal a particular device as to the appropriate timing when communicating with other devices. As discussed above, each component may be directly coupled to the other devices in the system 400 as shown by way of example with signal line 408, or may be connected to a LAN.

Each worker 104a-n may also be configured to communicate signals directly to the IIO device 106. This would allow each worker 104a-n to generate a receipt for the IIO device 106.

Due to the system's 400 distributed communication scheme, the system 400 is easily scalable since the command system 102 merely has to control the timing of each worker's processing and communications, and does not have to handle the larger document image files. In one embodiment, such document image files may be transmitted between workers 104a-n or between the workers 104a-n and the IIO device 106 via the LAN. Such worker 104a to worker 104b communication is shown representatively by signal line 408 but could be between any of the workers 104a-n. Additionally, a distributed topology such as system 400 may be the easiest to integrate into a pre-existing network environment. An alternate embodiment allows the workers 104a-n themselves to communicate the identification of the next worker 104a-n to the command system 102 allowing the command system 102 to control the invocation of the next worker 104a-n without requiring prior knowledge of the identification of the next worker 104a-n.

While the above system 400 may have increased scalability because the command system 102 is only required to process the workflow data at the beginning and the end of the workflow, it is has a cost. As described above, the system 400 requires that each worker 104a-n be told something about the next worker 104a-n in the workflow. The process for telling the worker 104a-n about other workers 104a-n may be cumbersome, and in smaller systems may not be necessary. Additionally, by allowing direct communication between the workers 104a-n, security may be more difficult to maintain.

FIG. 5 illustrates a third embodiment for a system 500 employing a central hub topology. System 500 includes the command unit 110, one or more IIO devices 106a-c, one or more associated user interface units 108a-c respectively for each IIO device 106a-c, and one or more workers 104a-c. As can be seen in FIG. 5, the command unit 110 is the means of communicating between each of the other devices 104a-c, 106a-c and 108a-c. Such a network configuration gives the command unit 110 much greater control over the operation of the workflow.

However, a hub topology such as in system 500 may be less scalable due to the sheer volume of data that would have to be managed by the command unit 110. One solution to reduce the volume of actual data processed by the command unit 110, is discussed above and includes having the command unit 110 handle all messages, but allows the workers 104a-c to access the IIO devices 106a-c directly to retrieve the scanned document image. For such a configuration additional lines would need to be added to FIG. 5 representing connections between each IIO device 106a-c and each worker 104a-c. For clarity's sake, these lines are not shown in FIG. 5.

Furthermore, while FIG. 5 shows only three workers 104a-c, three IIO devices 106a-c and three user interface units 108a-c, those skilled in the art will realize there may be any number of workers 104a-c, IIO devices 106a-c and user interface units 108a-c. In general, it is preferred that there are the same number of user interface units 108a-c as IIO devices 106a-c so that each user interface units 108a-c can be used to accessed a particular IIO device 106a-c. However, multiple IIO devices 106a-c may share a single user interface unit 108. Also, the number of workers 104 may differ significantly from the number of user interface units 108 and IIO devices 106.

Additionally, this hub topology may be the easiest to diagnose and to configure. This topology may also cut down on non-essential messaging in the system 500 since each device 104a-c, 106a-c and 108a-c communicates with the command unit 110. This may save on the complexity of each device 104a-c, 106a-c and 108a-c and the instructions provided to them. By having the command unit 110 perform all messaging services, security in the system 500 may also be stricter.

FIG. 5 illustrates the third embodiment of the system 500 as implemented in hardware. Similar to FIG. 4, the signal lines 502a-c, 504a-c and 506a-c connecting the various components 104a-c, 106a-c and 108a-c are graphical representations of communications channels between the components 104a-c, 106a-c and 108a-c and do not necessarily represent direct physical connections. As discussed above in FIG. 4, each device 104a-c, 106a-c and 108a-c in the system 500 may be each coupled to a LAN to facilitate the communication.

One skilled in the art will recognize that other hardware devices may be used in the command system 102, workers 104, and IIO devices 106. For example, FIG. 6 illustrates a system 600 utilizing the components of a general-purpose computer system. The command system 102 may be implemented in a workstation computer 610 sitting on the user's desk. The IIO device 106 may be a scanner 620, and the receipt output device may be a laser printer 630. The workstation 610 may do all of the workflow processing on its own, or may communicate via a network 650 (LAN or WAN etc) with additional computers 640 which may perform parts of the workflow process and are the worker 104. While the system 600 has been illustrated using a printer 630 that is connected only to workstation 610, the system 600 may instead use a network printer, thereby allowing any of the additional computers 640 to print a receipt directly to the printer.

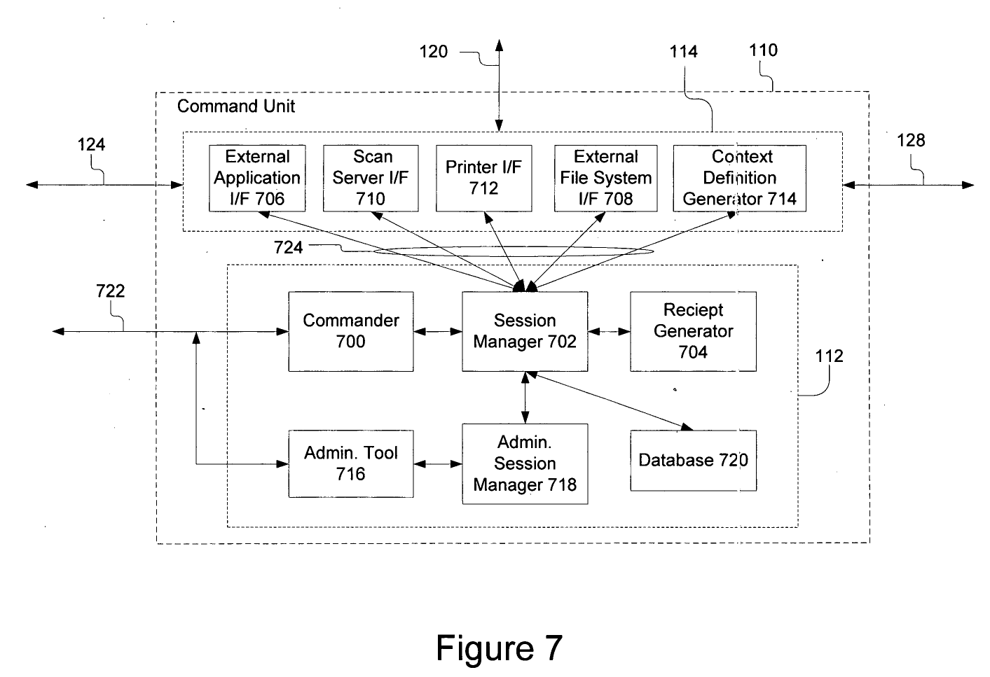

Referring now to FIG. 7, another embodiment for the command unit 110 is shown. In this embodiment, the command unit 110 again comprises a device interface 114 and a context server 112. FIG. 7 shows the device interface 114 and a context server 112 in more detail. For example, the device interface 114 may include a plurality of interfaces including an external application interface 706, a scan server interface 710, a printer interface 712, an external file system interface 708, and a context definition generator 714. The context server 112 further comprises a commander 700, a session manager 702, a receipt generator 704, an administrative tool 716, an administrative session manager 718 and a database 720. The command unit 110 has the functions specified above and the context server 112 is responsible for providing that functionality. With regard to couplings, like reference numerals have been used consistent with the couplings shown in FIG. 1A.

The command unit 110 advantageously uses the image context to determine how to further process the information. The primary purpose of the command unit 110 is to associate an image with a context and corresponding metadata so that when the image is provided to the worker 104, the image and data can be processed correctly according to the workflow. Essentially, the command unit 110 ensures synchronization between the context and the image for proper processing. More specifically, the context server 112 of the command unit 110 creates sessions to set a context for the scanning of images so that the worker 104 knows how to process the image once it is received. More generally, the command unit 110 acts like a workflow traffic cop without having to know the structure of the workflow. In particular, the present invention is particularly advantageous because the context server 112 does not need to know the workflow, but merely needs to be able to pass data and commands to device interfaces 114. In an alternate embodiment, the context server 112 could include additional modules such that it more actively managed and had knowledge of the data workflow. The command unit 110 merely takes prompts to gather data and translates them into a form understandable to the IIO device 106 and the user interface unit 108. A session is the construct that the present invention uses to manage the workflow. This is particularly advantageous because it allows any existing IIO devices 106 such as photocopiers to be used with the system 100. The IIO devices 106 can be “dumb” devices and not know what additional processing must be done with the image, merely that a document must scanned and sent to the command unit 110. Even the message to the worker 104 which initiates the workflow (say choosing “Expense Report”) is just a message whose content is “start expense report,” and the worker 104 will reply to that message by sending the first prompt and list of choices for the expense report workflow. Thus, the worker 104 makes the decisions regarding workflow logic; it tells what to put on the display and how to label the responses, and it decides what to display next after receiving those responses. The command unit 110 only needs to know the names of the applications to offer to each user, and how to find the right worker 104 and initiate a workflow on it. The command unit 110 preferably does not keep state information about the workflow (except for knowing how to initiate and how to recognize a “quit” command). The user interface unit 108 returns the user's context selection name (e.g. “buttonValue=Hotel”) along with a scanned image back to the worker 104. By shuttling generic choices and images back and forth, the command unit 110 mediates between numerous workers 104 and IIO devices 106, but doesn't have to store the application logic of any particular application (and hence doesn't need to be reprogrammed or synchronized when new applications or workers 104 are created or old ones change their flow). Those skilled in the art will recognize that a key advantage of the present invention is that the command unit 110 acts as a state-less traffic-cop that allows backward compatibility to pre-existing systems with minimum modification of such pre-existing systems in order to add the functionality of the present invention.

The external application or worker interface 706 couples the context server 112 to the worker 104 via signal lines 124. The external application interface 706 translates commands and data from the context server 112 into a format that is understandable by the worker 104. For example, the worker 104 may be a business application running on a server. The external application interface 706 translates the commands, data and references to other workers 104 so they are in a form usable by the business application. These may be based on existing standards for applications or may be specifically designed based on the particular worker 104. In a preferred embodiment, the context server 112 and the worker 104 communicate using messages. The messages from the worker 104 to the context server 112 may then be passed on to the user interface unit 108 through the external file system or control interface 708. An exemplary template for messages sent from the worker 104 to a user interface unit 108 include: 1) a prompt (string, e.g. “choose one of the following”); 2) choices (list of strings, e.g. “Hotel, Airfare, Car”); 3) a choice label (the name of the variable to which to assign the chosen string upon return, e.g. “ReceiptType”); 4) a button name (string with which to label the button, e.g. “Scan this receipt”); 5) a button command (name of variable to return upon pressing the button, e.g. “SelectNewReceipt”); 6) a text label (variable name to which to assign freely-typed text input upon return, e.g. UserName); 7) a scanning instruction (e.g., ScanOnePage instructs UI to display a button whose effect is to scan one page or ScanMultiplePages instructs UI to display a button whose effect is to scan multiple pages). Those skilled in the art will recognize that a message may have any one of these items or may exclude some entirely. Preferably, the message templates are a stripped-down version of HTML, in which you can display only a few things (via “prompt”) and collect a few things (choices, button-presses, and text). The system 100 can be used to have the user enter their name and password via the “TextLabel” item (which would display a text box), and could offer logout via a button called “Quit.” The net effect is that the context server 112 just relays messages from the user interface device 108 to and from the worker 104, without itself having a script of the workflow; that script is held by the worker 104, not by the context server 112.

The external file system or control interface 708 couples the context server 112 to the user interface unit 108. The external file system interface 708 translates commands and data so that they may be issued via line 120 from the context server 112 to the user interface unit 108. This includes providing commands that the user interface unit 108 understands as well as receiving commands and data from the user interface unit 108. For example, the context server 112 causes the user interface unit 108 to display information and one or more choices to the user. The user interface unit 108 in response receives input from the user and passes it back to the context server 112 for further processing or transmission to the appropriate worker 104. A specific example of a sample communication from the user interface unit 108 to the context server 112 and on to any worker 104 is messages of paired results. Messages from the user interface unit 108 are preferably name-value pair results of user choices that correspond the items in the exemplary template described above. For example, a message from the user interface unit 108 to a worker 104 may be:

ReceiptType=Hotel

SelectNewReceipt=yes

UserName=Joe Smith

ScannedPage=/files/images/scan123.jpg

It should be understood that the command unit 110 does determine and specify the formatting for the content from the worker 104. The command unit 110 specifies display and format (fonts, colors, spacing). Only the command unit 110 knows what kind of display (built-in, PDA, full-screen, etc) and capabilities a particular user interface unit 108 has.

The scan server interface or image capture interface 710 couples the context server 112 to the IIO device 106. The scan server interface 710 provides a mechanism for sending commands and data from the context server 112 to the IIO device 106. In the preferred embodiment, the scan server interface 710 knows the API for the IIO device 106 and sends commands and data to the IIO device 106 in accordance with the API. The scan server interface 710 may also include processes or methods that “encapsulate and localize” interaction with the IIO device 106, enabling the context server 112 to work using a single internal data representation. This allows the context server 112 to interact with multiple types of IIO devices 106 using a single, standard command language with little or no regard to the proprietary specifications of each model of IIO device 106. An example interaction between the context server 112 and the scan server interface 710 is given as follows. The context server 112, through the scan server or scan server interface 710, sends commands to activate the IIO device 106, start scanning or display information or choices on a display panel of the IIO device 106. The scan server interface 710 also receives commands and data from the IIO device 106. For instance, once an image has been scanned it can be stored at the IIO device 106 and a reference to the location where the image is stored is sent to the context server 112 or the scanned image itself can be sent to the context server 112.

The printer or image output interface 712 is similar to the scan server interface 710, but for providing images and commands to IIO device 106. The printer interface 712 provides a mechanism for sending images to be printed and commands from the context server 112 to the IIO device 106. In the preferred embodiment, the printer interface 712 knows the API for the IIO device 106 and sends commands and data to the IIO device 106 in accordance with the API. The printer interface and the scan server interface 710 are, in reality, bundled together in the same component so that there is only one process that manages interaction with IIO device. For example, the context server 112 through the image output interface 712 sends commands to print an image representing a receipt. The scan server interface 710 also receives commands from the IIO device 106 such as confirmation that the data has been received, and that a receipt has been printed.

The context definition generator 714 is used to communicate with the user interface unit 108 and the context server 112 to generate a context definition. This would include identifying the type of document, an associated worker, and a reference to context definition templates stored in the database 720. The context definition generator 714 creates the context definition processing of an input document, where the output will be provided and defines the interactions between the user interface device 108, the command unit 110 and one or more workers 104.

As noted above, the context server 112 includes the commander 700, the session manager 702 and the receipt generator 704. The receipt generator 704 is preferably implemented in software and has a number of routines for receiving an image, and adding other images and data to it to form a receipt. The receipt generator 704 is also communicatively coupled to the IIO device 106 by the image output interface 712 to have the receipt printed by the IIO device 106.

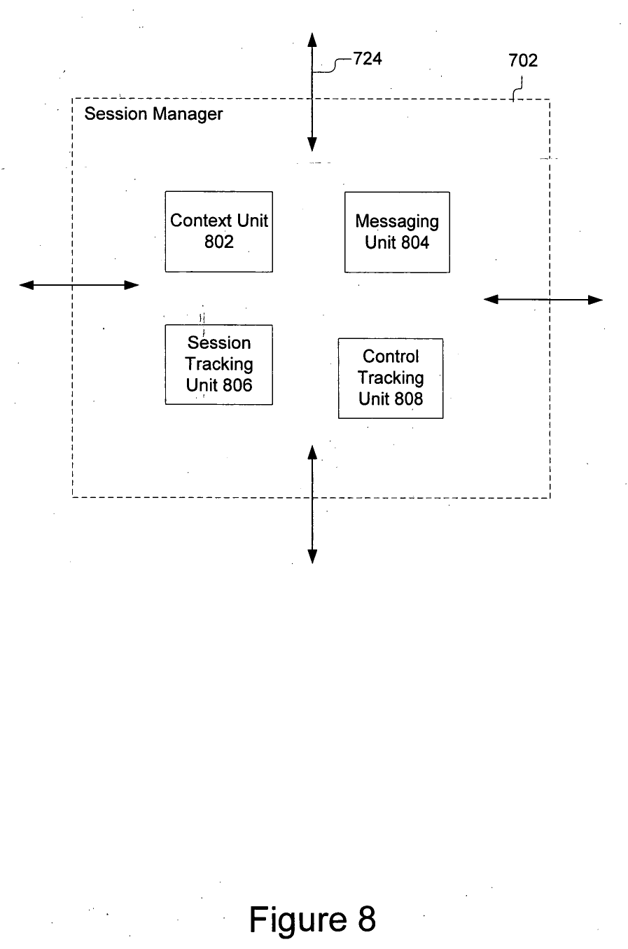

The operation of the session manager 702 has been described above. In general, the session manager 702 manages data transmission and receipt from the context server 112 to any number of IIO devices 106 and workers 104. The session manager 702 is responsible for creating, operating and terminating a plurality of user sessions some of which may be operating simultaneously. The session manager 702 uses the context definition to control data and command traffic between the context server 112, the workers 104, the IIO devices 106 and the user interface devices 108. The session manager 702 is coupled to the commander 700, the receipt generation 704 and the device interfaces as illustrated in FIG. 7. The session manager 702 will be described in more detail with reference to FIG. 8.

The commander 700 is used to start the user sessions. The commander 700 is coupled to signal line 722 to provide access to control the operation of the context server 112. The commander 700 preferably communicates via signal line 722 to a web browser (not shown) for sending and receiving data. The commander 700 signals the session manager 702 to create a user session, after which the session manager 702 operates the sessions to completion.

The context server 112 also includes an administrative tool 716, an administrative session manager 718, and a database 720.

The administrative tool 716 provides a function similar to the commander 700 but for administration and operation of the context server 112. The administrative tool 716 is also coupled to signal line 722 to a web browser (not shown) to receive commands on operating parameters and data for the context server 112. In particular, the administrative tool 716 creates one or more administrative sessions to ensure the context server 112 is operating properly by providing a means through which context definitions, as they relate to applications, scanned images, access to workers 104, and receipt layouts, can be created and maintained.

The administrative session manager 718 is similar to the session manager 702, except the administrative session manager 718 maintains a working memory and a plurality of administrative sessions that can be used to modify the working memory of the context server 112 to modify or change any addresses, parameters or other information used to access users, output (printing) devices, input (scanning) devices, context definitions, external applications, receipt formats and context definition generators 714.

The database 720 is coupled to the session manager 702 and in one embodiment is preferably a database of XML files. The database 720 preferably includes user profiles, context definition templates, receipt formats, device profiles and application control definitions. The session manager 702 in creating user sessions accesses the database 720. The session manager 702 retrieves information necessary to complete the session from the database 720 and loads it into working memory during the session.

Referring now also to FIG. 8, the session manager 702 will be described in detail. The session manager 702 is preferably implemented in software and has a number of routines for creating, modifying and ending sessions which are the basic structure used by the present invention to control, monitor and communicate as necessary for a workflow. More particularly, the session manager 702 preferably includes a context unit 802, a messaging unit 804, a session tracking unit 806 and a control-tracking unit 808. Although not shown, the session manager may also include a file management unit, and a security unit.

The session manager 702 uses the context unit 802 to maintain state information about the current context of a session. Examples of context may include: who is logged in, what application is being run, what the user's most recent action was, what IIO device 106 is being used and the current date and time. For each session, the context of the user interface unit 108 and the IIO device 106 are maintained. For example, there may be a message sent to the user interface unit 108 and the context unit 802 stores that context. This also provides temporary storage for information from a worker 104 with regard to the state of the workflow.

The messaging unit 804 communicates with each of the interface units 706, 708, 710, 712, and 714 to receive messages from them, and then to create new messages and send those new messages to the appropriate interface. In some instances, the messages are merely passed along by the messaging unit 804. In other instances, the messaging unit 804 adds formatting information to the message that can be used by the device interface 114 so that the recipient will know how to use the content. In still other instances, the messaging unit 804 translates the message from one format understood by a worker 104 to another format understood by a different worker 104 using a different protocol or the user interface unit 108. Also, that messaging function could include which transmission protocol to use: http, TIBCO-RV, SOAP, JMS etc). Finally, in yet other instances, the message unit 804 adds content and formatting information from the context definition to the message for use by the device interface 114 before sending it on to the worker 104, the IIO device 106 or the user interface unit 108.

The session tracking unit 806 is used to track and maintain each session. One of the advantages of the present invention is that the command unit 110 may be coupled to multiple workers 104a-c, multiple IIO devices 106a-c and multiple user interface devices 108a-c. Thus, there may be multiple sessions operating in the system 500 simultaneously. The session tracking unit 806 maintains these separate sessions and manages the context unit 802, the messaging unit 804 and the control-tracking unit 808 for each session. This ensures that different sessions using different workers 104a-c, IIO devices 106a-c and user interface units 108a-c can be operational as well as multiple sessions using the same worker 104a, IIO device 106a and user interface unit 108a.

The control-tracking unit 808 is used to monitor the current state of a session. The control-tracking unit 808 monitors the processing of messages and ensures that the session does not stall, or if the session times out, that an error is generated. The control tracking unit 808 monitors whether a workflow has been initiated, and if so, it monitors the messages to make sure that every message is processed, and where responses to messages are required they are received.

### Example Workflows for the Document Processing System 100

Below are provided several brief examples of possible workflows that may be implemented using the system 100 described above.

Timestamp

This workflow is very similar to ordinary copying. However, the returned copies may also include a timestamp on the top/bottom/margin, a copier ID, user name, or a tracking number too.

Recipient Receipt

This workflow is similar to the timestamp, but with a certification that some receiving application (email server, image processor, document control server) actually got the received the image. This is a very simple concept of the receipt provided by the present invention, and how it can be provided for any action performed by the system 100.

Pay for Copy

If the IIO device 106 is a copy machine with capability for a remote “copy” command, the ordinary physical “copy” button on the IIO device 106 may be disabled in order to force the user to submit copy requests via the command interface of the present invention. The context server 112 will force the user to enter a name (or department, or charge-code), will keep track of how many copies are being made, and will not only produce the copies but will compute the charges directly and output a receipt of those charges to the user. This workflow allows offices to track and charge copier usage without having to purchase the expensive copy machines and systems which normally perform such functions.

Virtual Letterhead

The user selects the letterhead workflow from the user interface unit 108. The user then copies one paper (with some designated blank area on it, e.g. at the top). The system 100 replaces the blank area with the letterhead (that has been previously stored in the system 100) and outputs a “receipt” which is a document containing the letterhead or logo image in the place of the blank area. The inserted image might come from electronic memory, or it might be copied in separately at the same time.

Word Count

The user may copy several pages, and a combination of OCR and word-count workers 104 will process the text on those pages. The receipt includes the number of words on each page, and the grand total of all pages.

Point-of-Sale System

This workflow embodiment is useful for stores, such as restaurants, that have a limited selection of things to order, and high peak-hour demand. Customers (users) take paper menus and check-off the items they want (e.g. with separate boxes for various quantities). Before reaching the cashier (or credit-card/ATM payment machine), the customer feeds the menu into a scanner (or copier), and is given a receipt containing both the image and the text of what was ordered and how much it costs. The same information that is on the receipt is also sent directly into the ordering system so the order is processed and the cashier/payment machine for payment. In another embodiment, the customer may also provide payment authorization on the sheet as well, and the payment process may also be automated, with the receipt reflecting the total transaction.

Calendar/Reservation Form

A user fills out a vacation request form, signals the system 100 to begin the calendar/reservation workflow, and inputs the form into the IIO Device 106. When the signed version is copied the system 106 extracts the information from the document, and the information is forwarded to a central calendar. The user receives back a printout of a calendar with that person's vacation days highlighted on the calendar as a “receipt.” This workflow may also work with other calendar-based transactions, like conference-room reservations, planned travel, etc.

Expense Report

The user presses the “expense report” button on the user interface unit 108 to signal the beginning of an expense report session. The user then copies many receipts that are required for submission, designating each type of receipt (e.g., “hotel”, “airfare” or other company defined codes). At a minimum, the system 100 creates a workflow receipt with a timestamp and a scaled-down image of each submitted receipt and its category. In addition, the system 100 might perform OCR on the submitted receipts, find the “total” on each one (e.g. the largest number in the lower right corner), copy the values into an electronic expense report form, and add them all up onto a summary sheet. The summary sheet is then output as a workflow receipt to the user, and may also be submitted to the appropriate department in the company for action. Alternatively, and electronic version of the receipt could be automatically entered into and enterprise application for approving and paying the expense to the employee.

Document Keyword Search

A user “copies” (scans) a document, and also inputs/copies a page containing a list of key words or phrases. The system 100 performs OCR on both documents and searches the first document for any of the words and phrases on the second document. The printed receipt then highlights all instances of the words or phrases in the copied document. In this application, the receipt is the final output.

Document Comparison

A user inputs two versions of a legal document (e.g., a proposed and a modified contract, or a proposed NDA vs. a boilerplate). The system 100 performs OCR on each, and the receipt is a document showing the parts of the documents that are in one document but not in another.

Mail Merge

The user copies an “example” form letter (or Christmas card etc.). In a first embodiment, the example contains a specific name and address (e.g., Mary Doe) in a specific font. In a second embodiment, the example letter may have specific markings for each field of information to be “merged.” The user also copies a list of many names and addresses, and values for the corresponding fields. In the first embodiment, one of the names is Mary Doe's. The machine performs OCR on everything, locates the name and address “Mary Doe” as the portion of the letter which is also on the name-list, and then prints out a series of modified copies of the letter, with Mary Does' name and address replaced in turn by the other names and addresses from the list (in the same font). In the second embodiment, the special markings are simply filled in with the list of information on the second copied document. The output letters constitute the receipt.

Feature Extraction

This workflow is similar to the mail merge workflow discussed above. But instead, the user starts with a series of completed form letters and receives a name-list as a receipt. First the user indicates that she wishes to perform feature extraction. Then the user copies a form letter with Mary Doe and her address, and another sheet showing just Mary Doe's name and address in separate columns. The system performs OCR on both documents and figures out where “Mary Doe” came from. The result is that the system 100 has been programmed with the desired feature to extract. Next the user then copies in the remainder of similar letters and the system 100 extracts from each document whatever text is where “Mary Doe” had been in the first letter. The system 100 then prints out a list of all the names as a receipt.

Purchase/Procurement Orders

The user first presses the “purchase order” button to select the desired context. Next the user selects the category of purchase and a value range, and then copies in a signed or unsigned purchase order. The system 100 performs OCR on the form, archives the digital image and routes the relevant information to the appropriate procurement and/or approval authority. A “stamped” and dated copy of the original purchase order is produced as a receipt which proves that the purchase order was submitted on a given date and time.

Automatic Translations

The user selects translation from the context menu on a command system 102 and copies a document in a foreign language. The system 102 performs OCR on the document, determines the language, and performs a translation (either locally or via an internet service). The receipt is the translated text, appearing in the original format.

Format Conversions

The user copies some text, and also copies a separate style sheet indicating (by name or example) the size and font type into which to convert the first set of text. The system 102 performs OCR on the original text, and then prints out a receipt with the original text in the desired font.

Business Information Display

In this example, a networked copier cannot only receive and forward information onto the network, but also can pull information from the network and send it to the user. For example, upon request (e.g. when the user copies a paper with his name and the word “Coffee Coupon”), the copier can produce a personalized receipt/coupon for the coffee shop next door. Such receipts can contain the user's name, product preference, bar codes, and may also be time-sensitive.

Automatic Test/Survey Scoring

The user selects test scoring as the context and enters one or more input documents (“answer keys”) to program the system 100 as to the particular details about the test, such as answer positions and correct answers etc. The user then copies at least one marked test or survey (i.e. taken by a student etc). The system 100 grades the marked test based on the initial programming and a corrected test—e.g. an image of the original marked test with right/wrong marks and comments superimposed—is output as a receipt. This system 100 may also be used to tally questionnaires. The receipt for questionnaires may be a return copy of the marked questionnaire including indication of detected answers and/or statistical or graphical summaries of all the marked answers from all questionnaires.

Pay-for-Print Invoice

Commercial pay-for-print copy centers typically count the number of copies purchased on a specific machine using special magnetic card readers or mechanical counters hard-wired into the copy machine itself. In one workflow of the present invention, the copy machine 106 instead would internally keep count of the number and type of copies made, and would both print out an invoice/receipt detailing the count and the expense total and also forward electronic versions of the same information over the network. In addition to being used in a commercial copy center, this workflow may also be useful in a service-oriented business that wishes to accurately distribute copier overhead costs to the client.

Lab Notebook Observation Referencing

In various research oriented industries such as biotechnology, medical device manufacturing and pharmaceuticals, research observations—whether early stage core research or in later pre-manufacture stage—are typically recorded in laboratory notebooks for reasons of convention and non-repudiation. In one workflow of the present invention, key observations contained in notebooks can be linked to structured result information by requiring the researcher to enter such results along with scans of the relevant pages of the lab notebook into the copy machine 106. In this case, the receipt would be reduced images of each relevant lab book page together with the structured result information as interpreted by the researcher.

Check Truncation

For use at an office that receives regular checks, such as a property office or a credit card company, a user selects the “Check Received” button on the user interface unit 108 and is presented with a list of customer names. Next, the user selects the appropriate name and is then prompted for the amount and date of the check. The system 100 then permits the user to scan the check. Once the system 100 receives the check image, it is archived and then sent (along with user-supplied meta-data) to a proprietary electronic payment interface via an application gateway (worker 104). The application gateway (worker 104) responds with status information such as “accepted” or “pending” with a timestamp which is added to the context information. The system 100 produces a copy of the original check along with meta-data supplied from both the user and the proprietary interface as a receipt.

Tax/Audit Evidence Submission

In the tax accounting industry, it is desirable for firms to provide audit-ready tax reports such that access to original document images is only a click away from numbers on stored electronic tax forms. A user selects the “Submit Tax Evidence” button on the user interface unit 108 and then the system 100 presents a pick list of clients and tax forms. The user selects a client and a tax forms and scans the relevant documentary evidence. For a given client, the user can scan multiple items of evidence relating to one or many forms. The system 100 archives the images and related meta-data and provides a “stamped” copy of the same as a receipt.

Insurance Applications/Claims Evidence Submission

In the insurance industry, it is desirable to provide audit-ready claims and application files whereby access to original document images is only a click away from numbers on stored electronic claims or application forms. A user selects the “Submit Claim (or Application) Evidence” button on the user interface unit 108 and then the system 100 presents a pick list of claims and/or application forms. The user selects the appropriate form(s), enters or selects the client name, and scans the relevant documentary evidence whether it is a police report, adjuster's report, property disclosure, or appraisal document. For a given client, the user can scan multiple items of evidence relating to one or many forms. The system 100 archives the images and related meta-data and provides a “stamped” copy of the same as a receipt.

Retail Brokerage Account Management

A user selects the “Account Management” button on the user interface unit 108 and is presented with a list of client accounts. Next, the user selects the appropriate account and is presented with a list of document types, “account application”, “risk profile”, “asset transfer request”, etc. Upon the selection of the appropriate document, the user is prompted for additional meta-data as is appropriate for the document such as “account type”, “risk tolerance”, “transfer amount”, etc. Once the required contextual information is entered, the system 100 enables the scan function and the original document can be scanned. The system 100 then archives the document image in the appropriate directory along with the user-supplied meta-data. A “stamped” and dated copy of the original document is produced together with the user supplied context information as a receipt.

Human Resources Management

A user selects the “Human Resources” button on the user interface unit 108 and is presented with a list of employee or candidate names. Next the user selects the appropriate name and is presented with a list of document types, “offer letter”, “performance review”, “resume”, etc. Upon the selection of the appropriate document, the user is prompted for additional metadata as is appropriate for the document such as “expiration data”, “grading number”, “interview rating”, etc. Once the required contextual information is entered, the system 100 enables the scan function and the original document can be scanned. The system 100 then archives the document image in the appropriate directory along with the user-supplied meta-data. A “stamped” and dated copy of the original document is produced together with the user supplied context information as a receipt.

Efficacy and Viability Test Submission

In the pharmaceutical, medical devices, biological and chemical product industries items in inventory are often subject to regular tests from independent labs in order to verify continued efficacy or viability. It is desirable from a regulatory and audit perspective to provide instant access to test histories for each inventory item such that test document images are a single click away from the results they claim. A user selects the “Submit Test Result” button on the user interface unit 108 and then the system 100 presents a pick list of test types. Next, the user selects the test type and the system 100 presents a pick list of relevant inventory numbers. The user identifies the tested inventory item(s), enters the required result meta-data, and scans the relevant certified test result form. The system 100 archives the images and related meta-data and provides a “stamped” copy of the same as a receipt.

The above description is included to illustrate the operation of the preferred embodiments and is not meant to limit the scope of the invention. The scope of the invention is to be limited by only the following claims. From the above discussion, many variations will be apparent to one skilled in the relevant art that would yet be encompassed by the spirit and scope of the invention.

What is claimed is:

1. A method for inputting data and performing an operation with the data, the method comprising the steps of:
setting a context;
creating a digital image of the data;
performing the operation using the digital image according to the context;
creating a document including information from at least a portion of the digital image; and
outputting the document

2. The method of claim 1 wherein the document includes context and result information in addition to a portion of the digital image.

3. The method of claim 1 wherein the step of setting the context includes receiving input from a user.

4. The method of claim 1 wherein the step of setting the context includes detecting a context selection from the data in the digital image.

5. The method of claim 1 wherein the step of setting the context includes selecting a software application with which to process the data in the digital image.

6. The method of claim 1 wherein the step of setting the context includes inputting commands using a portable computing device.

7. The method of claim 1 wherein the step of creating the document and outputting the document are performed after the step of performing the operation has been confirmed to be complete or started.

8. The method of claim 1 wherein the step of performing the operation includes processing the digital image according to a workflow having one or more workers.

9. The method of claim 8 wherein the step of performing the operation includes a plurality of processing steps each processing step being done by a different worker.

10. The method of claim 1 wherein the step of performing the operation includes processing the digital image with an application workflow operating on an enterprise server.

11. The method of claim 1 wherein one from the group of a digital copier and a scanner performs the step of creating a digital image of the data.

12. The method of claim 1 wherein:
the step of creating a digital image of the data includes scanning at least one page to produce a scanned page; and
the step of creating a document includes generating a document that includes a reduced image of the scanned page along with confirmation information.

13. The method of claim 12 wherein the confirmation information includes at least one from the group of: time of processing, identification of a worker that performed processing, user identification, confirmation that processing completed, tracking number and error notification.

14. The method of claim 1, wherein the operation is scoring a test or tabulating a survey.

15. The method of claim 1, wherein the operation is generating copies, and the step of outputting the document includes printing a receipt that indicates the number of copies made.

16. The method of claim 1, wherein the operation is searching an information storage system and returning results, and the step of outputting the document is printing a receipt that indicates the returned results.

17. The method of claim 1, wherein the operation is language translation and step of outputting the document is printing a document that is translated to a different language.

18. The method of claim 1, wherein the operation is check processing, and the step of outputting the document is printing a copy of an original check and data relating to processing of the original check.

19. The method of claim 1, wherein the operation is input of documentary evidence into a computing system and step of outputting the document is printing a receipt that includes confirming information that documentary evidence has been stored, and data or forms associated with the documentary evidence.

20. The method of claim 19, wherein the documentary evidence is an original document required as evidence for tax or insurance purposes.

21. The method of claim 1, wherein the operation is determining the number of words input, and step of outputting the document is printing a receipt with the number of words on each page, and a total number of words.

22. The method of claim 1, wherein the operation is inputting an order into a system, and step of outputting the document is printing a receipt that confirms the order.

23. The method of claim 1, wherein the operation is making a reservation, and the step of outputting the document is printing a receipt that includes date, time, and location of the reservation.

24. The method of claim 1, wherein the operation is creating an expense report, and the step of outputting the document is printing a copy of the expense report.

25. The method of claim 24, wherein the step of creating a digital image of the data includes scanning a plurality of receipts.

26. The method of claim 1, wherein the operation is reporting scientific results, and the step of outputting the document is printing a receipt that includes date, time, reported result information, and images of relevant observations as contained in laboratory notebook pages.

27. The method of claim 1, wherein the operation is document comparison, the step of creating a digital image includes scanning a first and second document, and the step of outputting the document is printing a marked up version of the first document showing the differences from the second document.

28. The method of claim 1, wherein the operation is optical character recognition, and the step of creating a digital image includes scanning a first document, and the step of outputting the document is printing a second document that is a representation of the digital data produced as a result of the optical character recognition operation.

29. The method of claim 28, wherein the operation also includes document comparison, the step of creating a digital image includes scanning a third document, and the step of outputting the document includes also printing a marked up version of the third document showing the differences from the second document.

30. A system for performing image processing, the system comprising:
an image input/output device for capturing and generating digital images;
a worker for processing digital images;
a command system having an input and an output for controlling the worker and the image input/output device, command system capable of receiving command from a user, the command system coupled to the image input/output device to receive and send digital images and control signals, the command system coupled to the worker to send and receive digital images and control signals.

31. The system of claim 30 where in the command system further comprises a user interface unit and a command unit, the user interface unit for receiving commands from a user and displaying context information, the user interface unit coupled to the command unit, the command unit coupled to the worker and the image input/output device, the command unit for sending and receiving data and commands between the worker and the image input/output device.

32. The system of claim 31 wherein the user interface unit is physically separate from the command unit.

33. The system of claim 32 wherein the user interface unit is a wireless device.

34. The system of claim 32, wherein the user interface unit is part of the image input/output device.

35. The system of claim 30, wherein the command system further comprises a second user interface unit for receiving commands from another user and displaying context information, the second user interface unit coupled to the command unit.

36. The system of claim 35, further comprising a second image input/output device, and wherein the second user interface unit is used to set and control the context for images scanned by the second image input/output device.

37. The system of claim 30 wherein the worker is an application server running a business application.

38. The system of claim 30 further comprising a second worker coupled to the command system and the worker.

39. The system of claim 30 wherein the worker is coupled to the image input/output device for sending digital images for output by the image input/output device.

40. The system of claim 30 wherein the image input/output device is a digital copier.

41. The system of claim 30 wherein the image input/output device is a scanner and a printer.

42. The system of claim 30 wherein the command system is a server.

43. The system of claim 30 wherein the command system further comprises:
a context server having an input and an output, the input of the context server coupled to image input/output device to receive captured images, and the output of the context server coupled to the worker to send control signals and digital images; and
at least one device interface having and input and an output, the input of the device interface coupled to a worker to receive modified images, and the output of the device interface coupled to the image input/output device to send control signals and digital images.

44. The system of claim 31 wherein the command unit includes a session manager for controlling and monitoring the processing of a digital image by the worker.

45. The system of claim 44 wherein the session manager further comprises a context unit to maintain state information about the current context of a session.

46. The system of claim 44 wherein the session manager further comprises a messaging unit for communicating with the user interface unit.

47. The system of claim 43 wherein the context server is a stateless controller that does not store workflow information.

48. A system for controlling operation of a worker, an image capture device and an image generation device, the system comprising:
a device interface having an input and an output, the input of the device interface coupled to a worker to receive modified images, and the output of the device interface coupled to the image input/output device to send control signals and digital images.
a context server having and input and an output, the input of the context server coupled to the device interface to receive captured images, and the output of the context server coupled to the device interface to send control signals and digital images; and
a user interface unit for outputting status and receiving input commands, the user interface coupled to the device interface.

49. The system of claim 48 wherein the context server includes a module for archiving images captured by the image capture device.

50. The system of claim 48 wherein the device interface includes a module that archives images sent to the image generation device.

51. The system of claim 48 wherein the context server includes a module to track images captured by the image capture device.

52. The system of claim 51 wherein the context server includes a module to create and output a log of the tracked images.

53. The system of claim 48 wherein the device interface generates a receipt that includes at least a portion of an image that was processed.

54. A computer readable medium for performing an image processing process, the computer readable medium comprising:
a context selection data reception module stored on the medium that couples to a workflow commander for receiving a context selection and for initializing a workflow session;
a digital image of a document, stored on the medium, to be processed by the workflow session;
a program, executable on a computer system for receiving the digital image, processing the image, responsive to the context selection, to create a modified document of the digital image, and outputting the modified document.
